(19) United States
(12) Patent Application Publication
(10) Pub. No.: US 2014/0139459 A1
(43) Pub. Date: May 22, 2014

(54) TOUCH DISPLAY DEVICE AND DRIVING METHOD THEREOF

(71) Applicant: InnoLux Corporation, Miao-Li County (TW)

(72) Inventor: Ching-Hsin Wu, Miao-Li County (TW)

(73) Assignee: InnoLux Corporation, Miao-Li County (TW)

(21) Appl. No.: 14/065,690

(22) Filed: Oct. 29, 2013

(30) Foreign Application Priority Data
Nov. 22, 2012 (TW) 101143612

(51) Int. Cl. G06F 3/041

(52) U.S. Cl. CPC G06F 3/0416
USPC 345/173

(57) ABSTRACT

The invention provides a touch display device including: a lower substrate including a first inner surface and an first outer surface, wherein a thin film transistor array is formed on the first inner surface and provided with a plurality of gate electrodes, an upper substrate including a second inner surface facing the lower substrate and a second outer surface, and a sensing electrode layer formed on the first outer surface or the second outer surface, wherein the plurality of gate electrodes supply touch driving signals for the sensing electrode layer and the sensing electrode layer senses touch locations.

### CROSS REFERENCE TO RELATED APPLICATIONS

This Application claims priority of Taiwan Patent Application No. 101143612, filed on Nov. 22, 2012, the entirety of which is incorporated by reference herein.

### BACKGROUND OF THE INVENTION

1. Field of the Invention

The present invention relates to a touch display device and a driving method thereof, and in particular, relates to a touch display device and a driving method thereof using a gate driver to output a touch driving signal.

2. Description of the Related Art

In touch display techniques, a touch sensor needs a driving electrode layer and a sensing electrode layer. A touch driving signal is output to each driving electrode disposed in the driving electrode layer successively and each sensing electrode disposed in the sensing electrode layer receives a signal and senses its variation. When a user's finger or other object touches the screen of a touch display, at the touch location, coupling capacitance generated between the electrode layers varies because capacitance generated between the finger and the electrode layers is added. The control chip then calculates the touch location by detecting the variation of the capacitance.

In this kind of structure, no matter in the case where the driving electrode layer and the sensing electrode layer are formed on the same plane and one of them is bridged to cross the other or in the case where the driving electrode layer and the sensing electrode layer are formed on opposite surfaces of a substrate, multiple photo masks are required in the manufacturing process. It is an ordeal on the yield rates and the costs.

In this regard, panel manufacturers are starting to develop single layer touch sensors to reduce manufacturing costs and thicknesses of devices. However, most of the current single layer touch sensing techniques cannot provide highly accurate multipoint touch detection, such that these techniques are only applied to low-end products. The value of the product cannot be raised.

In view of this situation, the invention provides a touch display device and a driving method thereof, which use a gate driver to output a touch driving signal to lower manufacturing costs and achieve highly accurate multipoint touch detection.

### BRIEF SUMMARY OF THE INVENTION

A detailed description is given in the following embodiments with reference to the accompanying drawings.

According to an embodiment, the invention provides a touch display device, including: a lower substrate comprising a first inner surface and a first outer surface, wherein a thin film transistor array is formed on the first inner surface and provided with a plurality of gate electrodes; an upper substrate comprising a second inner surface facing the lower substrate and a second outer surface; and a sensing electrode layer formed on the first outer surface or the second outer surface, wherein the plurality of gate electrodes supply touch driving signals for the sensing electrode layer and the sensing electrode layer senses touch locations.

In the touch display device, the sensing electrode layer is formed from a plurality of sensing electrodes, and the arrangement direction of the sensing electrodes intersects with the arrangement direction of the gate electrodes.

In the touch display device, when the sensing electrode layer is formed on the second outer surface and a common electrode layer is formed on the first or second inner surface, the common electrode layer is formed from a plurality of common electrodes of which the number and the arrangement manner correspond to the plurality of the sensing electrodes.

In the touch display device, when the plurality of gate electrodes outputs the touch driving signals, the plurality of the common electrodes are floating.

In the touch display device, when the touch driving signals are output, a predetermined number of adjacent scan electrodes are taken as a group and each group outputs one of the touch driving signals successively.

In the touch display device, the touch driving signals are output in a blanking period which is between two adjacent frames.

In the touch display device, the period for which all of the plurality of gate electrodes output the touch driving signals is a sensing frame, and the blanking period includes at least one sensing frame.

The touch display device further includes: a gate driver receiving a first clock signal to output scan signals during the frame period and receiving a second clock signal to output the touch driving signals during the sensing period, wherein the pulse width of the second clock signal is shorter than or equal to the pulse width of the first clock signal.

The touch display device further includes a backlight module which is turned off when the touch driving signals are output.

According to an embodiment, the invention provides a driving method of the above touch display device, including outputting a scan signal to each of the plurality of the gate electrodes successively; and taking a predetermined number of the adjacent gate electrodes as a group and outputting the touch driving signal to each group successively.

According to the above touch display device and diving method thereof, the manufacturing cost is reduced, the yield rate is improved, and the requirements of achieving highly accurate multipoint touch is satisfied.

### BRIEF DESCRIPTION OF THE DRAWINGS

The present invention can be more fully understood by reading the subsequent detailed description and examples with references made to the accompanying drawings, wherein:

FIG. 1 is a section view of a touch display device in accordance with an embodiment of the invention;

FIG. 2 is a top view of the touch display device shown in FIG. 1;

FIG. 3 is a timing chart showing the timing when the gate driver sends scan signals to each gate electrode.

FIG. 4 is a timing chart showing the timing when the gate driver sends touch driving signals to each gate electrode.

### DETAILED DESCRIPTION OF THE INVENTION

The following description is the embodiments of the invention. This description is made for the purpose of illustrating the general principles of the invention and should not be taken in a limiting sense.

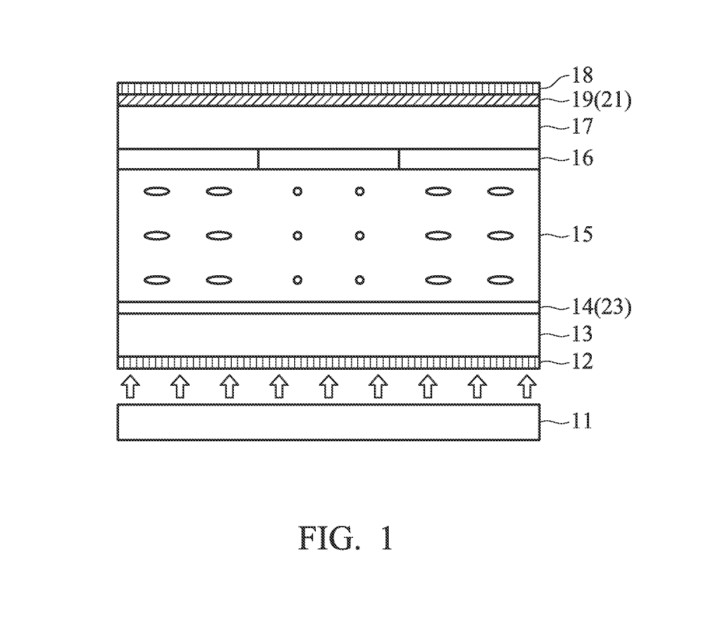

FIG. 1 is a section view of a touch display device in accordance with an embodiment of the invention. As shown in FIG. 1, a basic structure of a liquid crystal panel of the embodiment comprises: a backlight module 11, a lower polarizer 12, a lower substrate 13, a thin film transistor array 14, a liquid crystal layer 15, a color filter film 16, an upper substrate 17, and an upper polarizer 18. The structure is the same as the structure of a conventional liquid crystal panel, so detailed descriptions are omitted. The feature of the embodiment is that a sensing electrode layer 19 is formed on the outer surface of the upper substrate 17 of the conventional liquid crystal panel. The sensing electrode layer 19 comprises a plurality of sensing electrodes 21 which are used as signal receiving electrodes of a touch sensor. Gate electrodes (scan lines) 23 of the thin film transistor array 14 are used as signal transmitting electrodes of the touch sensor.

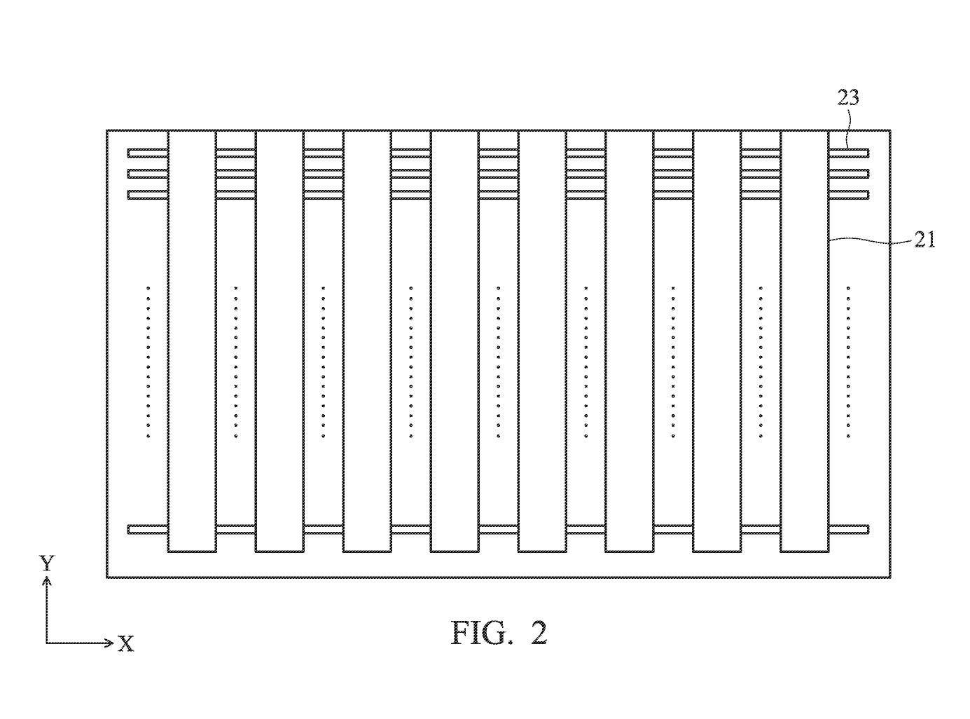

FIG. 2 is a top view of the touch display device shown in FIG. 1. In a touch sensor, the signal receiving electrodes are usually perpendicular to signal transmitting electrodes. Therefore, in the embodiment, when the gate electrodes 23 of the touch display device are parallel to an X-direction, the sensing electrodes 21 are parallel to a Y-direction. Note that it is not indispensable the sensing electrodes are perpendicular to the gate electrodes. As long as an algorithm of touch sensing is adjusted accordingly, the sensing electrodes and the gate electrodes only need to be intersecting each other.

In this structure, the gate electrodes 23 must function as scan lines scanning each thin film transistor of the thin film transistor array 14 to allow video data being written into each pixel and as driving electrodes outputting touch driving signals for the sensing electrode layer 19. The detailed driving method of the gate electrodes 23 is described later.

In addition to being arranged on the outer surface of the upper substrate 17, the sensing electrode layer 19 can be arranged on the outer surface of the lower substrate 13. That is to say, the invention does not limit the arrangement of the position of the sensing electrode layer 19. It is only required that the single sensing electrode layer 19 and a liquid crystal panel form a lamination structure. Note that in an IPS (In-Plane Switching) type liquid crystal display (as shown in FIG. 1), common electrodes and gate electrodes 23 are both formed on the inner surface of the lower substrate 13, so the sensing electrode layer 19 can be selectively formed on the outer surface of the upper substrate 17 or the outer surface of the lower substrate 13. However, in a VA (Vertical Alignment) type liquid crystal display, the common electrode layer is formed on the inner surface of the upper substrate (the color filter side). If the sensing electrode layer 19 is formed on the outer surface of the upper substrate 17, in order to avoid the common electrode layer shielding the touch driving signals transmitted by the gate electrodes 23, the common electrode layer is formed by many stripes corresponding to the sensing electrodes 21, and the common electrode layer is floating when the gate electrodes 23 output touch driving signals.

According to the above embodiment, the structure of the touch display device is simpler than a conventional multi-layer structure formed from a liquid crystal panel, a driving electrode layer, a sensing electrode layer, and dielectric layers therebetween. The manufacturing cost is reduced and the yield rate is improved. Moreover, the touch driving signals outputted from the gate electrodes are generated by the gate driver. Thus, a driving IC for a conventional touch sensor can be reduced such that the cost is further reduced.

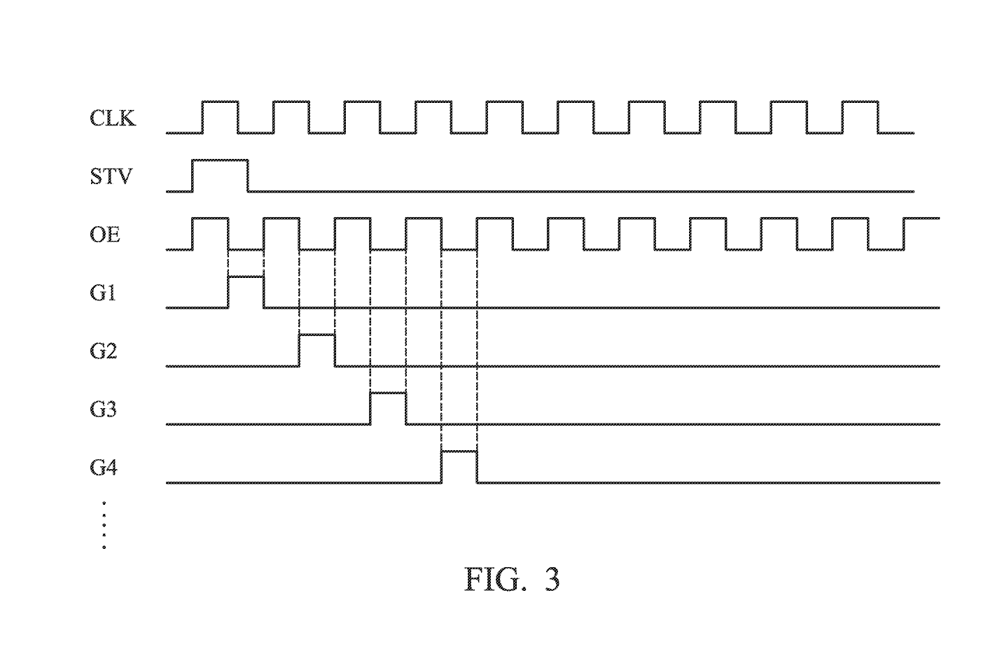

Following, a driving method of the touch display device in accordance with an embodiment of the invention is described. FIG. 3 is a timing chart showing the timing when the gate driver sends scan signals to each gate electrode.

The gate driver comprises shift registers connected in series and an output control circuit. The shift register shifts the logic level of an input signal to the next shift register according to a clock signal. The output control circuit outputs an output enable signal to control a pulse width of the signal sent from the shift register to the gate electrode.

The timings and the pulse widths of a clock signal CLK, a start signal STV (the input signal of the first shift register), and an output enable signal OE are shown in FIG. 3, for when the gate driver outputs scan signals to each gate electrode. The pulse width of the start signal STV covers a pulse width of the clock signal CLK, such that each shift register successively outputs an output signal having a pulse width equal to the period of the clock signal CLK. The output control circuit controls the output signal from the each shift register to be output to the gate electrode only when the output enable signal OE is at a low logic level. Therefore, the gate electrode signals G1, G2, G3, G4, . . . are sent to gate electrodes as scan signals.

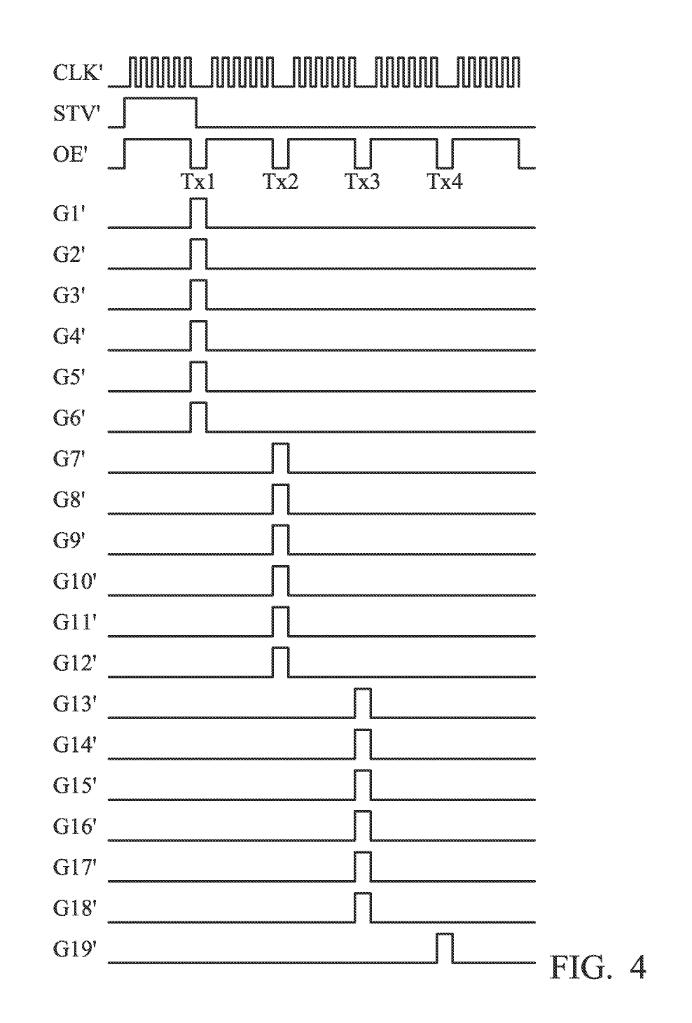

The frame rate of a general display is 60 Hz. This means 60 frames (images) are displayed per second. Therefore, the refresh period for a gate electrode is 1/60 second, and this period is called a frame period. In an embodiment of the invention, the timing when the gate electrode outputs a touch driving signal for touch sensing is in a blanking period between two frames. FIG. 4 is a timing chart showing the timing when the gate driver sends touch driving signals to each gate electrode.

Because the area of a touch point is much larger than the area of a pixel, the widths of the signal receiving electrode and the signal transmitting electrode in the touch sensor are made larger than those of the gate electrode and the source electrode in the display panel. In the invention, when the gate electrode is used to output the touch driving signal, a plurality of adjacent gate electrodes will be taken as one signal transmitting electrode and jointly output a touch driving signal.

The timings and the pulse widths of a clock signal CLK′, a start signal STV′, and an output enable signal OE′ are shown in FIG. 4, for when the gate driver transmits touch driving signals to each gate electrode. In this embodiment, 6 gate electrodes are taken as one signal transmitting electrode. Thus, the pulse width of the start signal STV′ covers 6 pulse widths of the clock signal CLK′. In this case, after 6 pulse widths of the clock signal CLK′ passing, the first to the sixth shift registers jointly output a high logic level signal. The output control circuit controls the output signal from each shift register to be output to the gate electrode only when the output enable signal OE′ is at a low logic level. Therefore, the gate electrode signals G1′, G2′, G3′, G4′, G5′, G6′, . . . are jointly taken as the first touch driving signal T×1 and output to 6 gate electrodes. Then after further 6 pulse widths of the clock signal CLK′, the gate electrode signals G7′, G8′, G9′, G10′, G11′, G12′, . . . are jointly taken as the second touch driving signal T×2 and output to the next 6 gate electrodes. In this manner, all of the gate electrodes finally transmit a touch driving signal.

The period for which the first to the last gate electrode transmit a touch driving signal is called a sensing frame. A general touch sensor needs at least 100 Hz sensing frequency for rapid touch sensing. Therefore, an entire touch sensor array is scanned at last 100 times per second. Because the sensing frequency of the touch sensor is higher than the frame rate of the display, a frame must be followed by a plurality of sensing frames. For easy understanding, it is assumed that the sensing frequency of the touch sensor is 300 Hz. In this way, after the entire thin transistor array of the display panel is scanned once to accomplish a frame, the entire touch sensor array of the touch sensor must be scanned 5 times to accomplish 5 sensing frames. Therefore, every blanking period is inserted with 5 sensing frames to perform both pixel scanning and touch scanning Because the frequency of the touch scanning is higher than the frequency of the pixel scanning, in the embodiment, the pulse width of the clock signal CLK′ in touch scanning is made shorter than the pulse width of the clock signal CLK in pixel scanning. However, for a simple design, the pulse width of the clock signal CLK′ can be equal to the pulse width of the clock signal CLK.

Further, when gate electrode transmits the touch driving signal, the transistors connected to the gate electrode are conducted such that the pixels on that row cannot stay at precise voltage levels and display incorrect gray levels. In this regard, in an embodiment of the invention, backlight blinking technology is also applied. In the period of touch scanning (including multiple sensing frames) the backlight is turned off to display a black image. In this way, touch scanning can be performed without affecting display performance.

According to the above driving method of the touch display device, only the clock signal, the start signal, and the input enable signal, which are input to the gate driver, are modified, and the gate electrodes can transmit touch driving signals to perform touch scanning. Therefore, the invention uses already existing gate electrodes and a gate driver to perform touch scanning. The invention substantially reduces the manufacturing cost and provides precise multipoint touch in high accuracy.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). For example, the number of scan electrodes taken as a signal transmitting electrode, the number of sensing frames following every frame, and etc. can be modified appropriately according the requirements of different kinds of products.

What is claimed is:

1. A touch display device, comprising
a lower substrate comprising a first inner surface and a first outer surface, wherein a thin film transistor array is formed on the first inner surface and provided with a plurality of gate electrodes;
an upper substrate comprising a second inner surface facing the lower substrate and a second outer surface; and
a sensing electrode layer formed on the first outer surface or the second outer surface,
wherein the plurality of gate electrodes supply touch driving signals for the sensing electrode layer and the sensing electrode layer senses touch locations.

2. The touch display device as claimed in claim 1, wherein the sensing electrode layer is formed from a plurality of sensing electrodes, and the arrangement direction of the sensing electrodes intersects with the arrangement direction of the gate electrodes.

3. The touch display device as claimed in claim 2, wherein when the sensing electrode layer is formed on the second outer surface and a common electrode layer is formed on the first or second inner surface, the common electrode layer is formed from a plurality of common electrodes of which the number and the arrangement manner correspond to the plurality of the sensing electrodes.

4. The touch display device as claimed in claim 3, wherein when the plurality of gate electrodes output the touch driving signals, the plurality of the common electrodes are floating.

5. The touch display device as claimed in claim 1, wherein when the touch driving signals are output, a predetermined number of adjacent scan electrodes are taken as a group and each group outputs one of the touch driving signals successively.

6. The touch display device as claimed in claim 1, wherein the touch driving signals are output in a blanking period which is between two adjacent frames.

7. The touch display device as claimed in claim 6, wherein the period for which all of the plurality of gate electrodes output the touch driving signals is a sensing frame, and the blanking period comprises at least one sensing frame.

8. The touch display device as claimed in claim 7, further comprising:
a gate driver receiving a first clock signal to output scan signals during the frame period and receiving a second clock signal to output the touch driving signals during the sensing period,
wherein the pulse width of the second clock signal is shorter than or equal to the pulse width of the first clock signal.

9. The touch display device as claimed in claim 1, further comprising:
a backlight module which is turned off when the touch driving signals are output.

10. A driving method of the touch display device as claimed in claim 1, further comprising:
outputting a scan signal to each of the plurality of the gate electrodes successively; and
taking a predetermined number of the adjacent gate electrodes as a group and outputting the touch driving signal to each group successively.
